(19) United States
(12) Patent Application Publication
(10) Pub. No.: US 2017/0160623 A1
(43) Pub. Date: Jun. 8, 2017

(54) FOCUSING PLATE AND VIEWFINDER SYSTEM HAVING THE SAME

(71) Applicant: CANON KABUSHIKI KAISHA, Tokyo (JP)

(72) Inventors: Fumihiro Shinobu, Utsunomiya-shi (JP); Yukiya Enokida, Kawasaki-shi (JP)

(21) Appl. No.: 15/356,146

(22) Filed: Nov. 18, 2016

(30) Foreign Application Priority Data
Dec. 4, 2015 (JP) 2015-237324

(51) Int. Cl. G03B 13/08; G02B 25/00; G02B 5/02; G02B 3/08; G02B 3/00

(52) U.S. Cl. CPC G03B 13/08; G02B 3/08; G02B 3/0056; G02B 5/0294; G02B 5/0215; G02B 25/001

(57) ABSTRACT

A focusing plate having a light entrance side and a light exit side includes a Fresnel lens disposed on one of the light entrance side and the light exit side to form a condensing surface, and a plurality of microlenses disposed on the other one of the light entrance side and the light exit side to form a diffusion surface. The relation between the arrangement period of microlens units arranged on the diffusion surface and the interval between annular sections of the Fresnel lens satisfies predetermined mathematical conditions.

### BACKGROUND OF THE INVENTION

Field of the Invention

The present invention relates to a focusing plate and a viewfinder system including the focusing plate, the focusing plate is suitable, for example, as a focusing plate used in a viewfinder system of a single-lens reflex (SLR) camera.

Description of Related Art

In a conventional imaging apparatus such as a single-lens reflex camera, a focusing plate is disposed at a position optically equivalent to an imaging surface. An object image formed on the focusing plate by an imaging optical system is observed through a viewfinder system. Many focusing plates used in single-lens reflex cameras have a diffusion surface on which an object image is formed, and a condensing surface that guides light rays exiting from the diffusion surface toward an eyepiece optical system of the viewfinder system.

Hitherto, a focusing plate in which a fine uneven structure is used as a diffusion surface for diffusing light rays has been known as a focusing plate for observing a viewfinder image. A microlens array in which fine microlenses are periodically or randomly disposed has been known as this fine uneven structure.

In a focusing plate, on one surface of which microlenses are periodically provided and on the other surface of which a Fresnel lens is provided, the interference between the periodic structure of the microlenses and the annular sections of the Fresnel lens creates a moire pattern, and sometimes makes the viewfinder image less visible. Methods for reducing this moire pattern include disposing a plurality of microlenses randomly. Although this method reduces the occurrence of a moire pattern, the graininess due to the random arrangement of microlenses may appear as black dots in the viewfinder image. Therefore, conventionally, a focusing plate having a configuration reducing this graininess and thus reducing the occurrence of a moire pattern has been proposed.

Japanese Patent Application Laid-Open No. 57-154214 discloses a focusing plate in which microlenses are periodically arranged, and the pitch of a Fresnel lens and the pitch of the microlenses are combined in a plurality of patterns. Japanese Patent Application Laid-Open No. 2012-203089 discloses a focusing plate in which a diffusion surface is formed using a plurality of types of microlenses.

In order to reduce the occurrence of the moire pattern while reducing the graininess of the diffusion surface, it is necessary to appropriately set the arrangement of the plurality of microlenses composing the diffusion surface, the pitch of the Fresnel lens composing the condensing surface, and the like. If these parameters are not correctly configured, it is difficult to reduce the occurrence of a moire pattern and to observe a good viewfinder image.

### SUMMARY OF THE INVENTION

The present application discloses a focusing plate that has a fine uneven structure with reduced graininess, in which the occurrence of a moire pattern is reduced, and with which a clear viewfinder image can be easily observed, and a viewfinder system having the same.

One aspect of the present invention is directed to a focusing plate having a light entrance side and a light exit side on one side of which a Fresnel lens is disposed to form a condensing surface and on the other side of which a plurality of microlenses are disposed to form a diffusion surface. The condensing surface is formed by arranging the center of the Fresnel lens aligned with the center of the one of the light entrance side and the light exit side, and the diffusion surface is formed by arranging the plurality of microlenses two-dimensionally at equal intervals. The apex interval between microlenses disposed adjacent to each other is longer than twice the interval between annular sections of the Fresnel lens.

Another aspect of the present invention is directed to a focusing plate having a light entrance side and a light exit side on one side of which a Fresnel lens is disposed to form a condensing surface and on the other side of which a plurality of microlenses are disposed to form a diffusion surface. The condensing surface is formed by arranging the center of the Fresnel lens aligned with the center of the one of the light entrance side and the light exit side, and the arrangement of the annular sections of the Fresnel lens is a concentric arrangement. The diffusion surface is composed of a plurality of microlens assemblies each formed by periodically arranging microlens units each formed by arranging microlenses having the same shape two-dimensionally at equal intervals. The repetition periods of microlens units included in the plurality of microlens assemblies differ from each other. The interval between two microlenses included in the microlens unit having the longest repetition period is longer than twice the interval between annular sections of the Fresnel lens.

Further features of the present invention will become apparent from the following description of exemplary embodiments with reference to the attached drawings.

### BRIEF DESCRIPTION OF THE DRAWINGS

FIGS. 1A and 1B are schematic views of a diffusion surface of a focusing plate of Example 1 of the present invention.

FIGS. 2A and 2B are schematic views of a condensing surface of the focusing plate of Example 1 of the present invention.

FIG. 3 illustrates a microlens unit of the diffusion surface of the focusing plate of Example 1.

FIG. 4 is a schematic diagram of the focusing plate according to the present invention.

FIG. 5 shows a relation between a microlens unit and the Fresnel lens annular sections in Example 1 of the present invention.

FIG. 6 illustrates a moire pattern occurring in the focusing plate of Example 1 of the present invention.

FIG. 7 is a schematic view of the interaction of light with Fresnel lens according to the present invention.

FIG. 8 is a schematic view of the interaction of light with the microlenses according to the present invention.

FIG. 9 illustrates the difference in lightness (intensity) of the moire pattern occurring in the focusing plate of Example 1 of the present invention.

FIGS. 10A and 10B are respectively top and cross-sectional schematic views of a diffusion surface of a focusing plate of Example 2 of the present invention.

FIGS. 11A and 11B are respectively top and cross-sectional schematic views of a condensing surface of the focusing plate of Example 2 of the present invention.

FIG. 12 illustrates a moire pattern occurring in the focusing plate of Example 2 of the present invention.

FIG. 13 illustrates microlens units of the diffusion surface of the focusing plate of Example 2 of the present invention.

FIG. 14 illustrates the difference in lightness (intensity) of the moire pattern occurring in the focusing plate of Example 2 of the present invention.

FIGS. 15A, 15B, and 15C respectively illustrate parts into which the moire pattern occurring in the focusing plate of Example 2 of the present invention is separated.

FIGS. 16A, 16B, and 16C respectively illustrate the difference in lightness (spectrum intensity) for each of the parts of the moire pattern in the focusing plate of Example 2 of the present invention is separated.

FIGS. 17A and 17B are respectively top and cross-sectional schematic views of a diffusion surface of a focusing plate of Example 3 of the present invention.

FIGS. 18A and 18B are respectively top and cross-sectional schematic views of a condensing surface of the focusing plate of Example 3 of the present invention.

FIG. 19 illustrates a moire pattern occurring in the focusing plate of Example 3 of the present invention.

FIG. 20 illustrates microlens units of the diffusion surface of the focusing plate of Example 3 of the present invention.

FIG. 21 illustrates the difference in lightness (spectrum intensity) of the moire pattern occurring in the focusing plate of Example 3 of the present invention.

FIGS. 22A, 22B, 22C, and 22D illustrate parts into which the moire pattern occurring in the focusing plate of Example 3 of the present invention is separated.

FIGS. 23A, 23B, and 23C respectively illustrate the difference in lightness (spectrum intensity) for each of the parts of the moire pattern occurring in the focusing plate is separated.

FIG. 24 is a schematic view of relevant parts of a single-lens reflex camera including a focusing plane according to the present invention.

### DESCRIPTION OF THE EMBODIMENTS

Embodiments of the present invention will be described below in detail with reference to the drawings. In one embodiment, the focusing plate includes a light entrance side and a light exit side on one side of which a Fresnel lens is disposed to form a condensing surface and on the other side of which a plurality of microlenses are disposed to form a diffusion surface. The diffusion surface is composed of a microlens assembly in which the plurality of microlenses are arranged two-dimensionally at equal intervals. The interval between two microlenses included in the microlens assembly is longer than twice the interval between the annular sections of the Fresnel lens.

In another embodiment of the present invention, the focusing plate includes a light entrance side and a light exit side on one side of which a Fresnel lens is disposed to form a condensing surface and on the other side of which a plurality of microlenses are disposed to form a diffusion surface. The diffusion surface is composed of a plurality of microlens assemblies, and the repetition periods of microlens units included in the plurality of microlens assemblies differ from each other. The interval between two microlenses included in the microlens unit having the longest repetition period is longer than twice the interval between the annular sections of the Fresnel lens.

Next, examples of the focusing plate of the present invention will be described.

### EXAMPLE 1

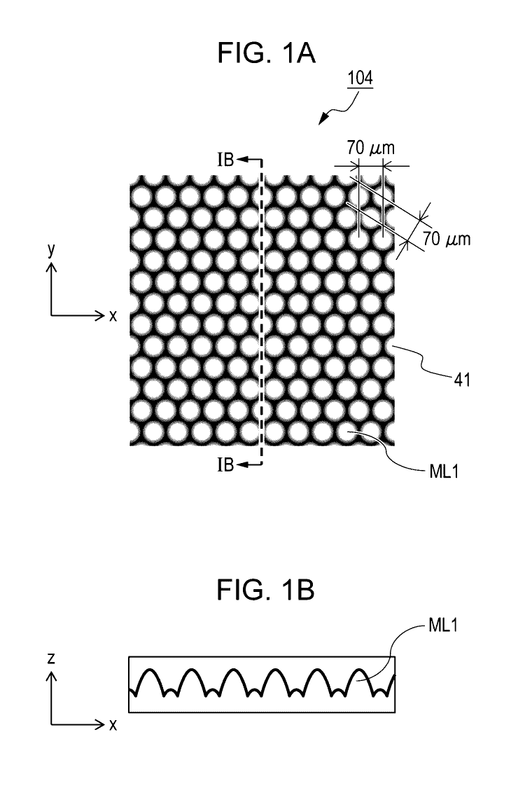

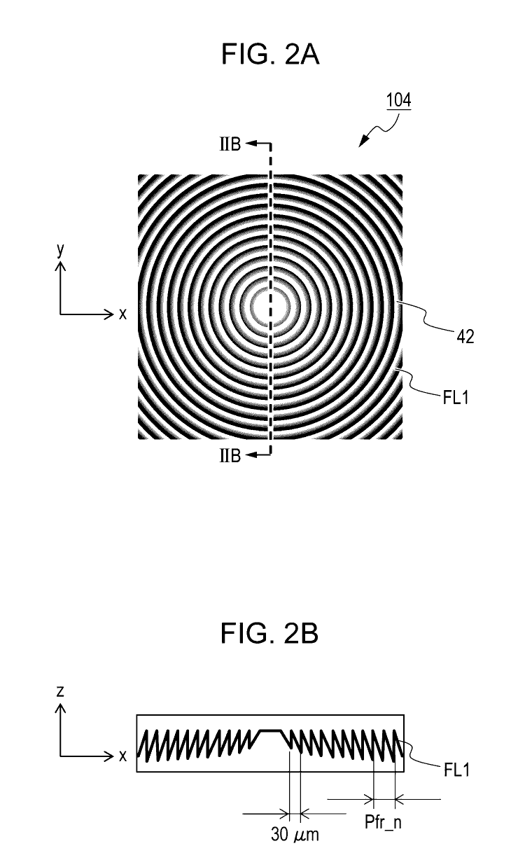

FIGS. 1A and 1B illustrate a focusing plate of Example 1 of the present invention. FIG. 1A shows the two-dimensional arrangement of microlenses ML1 composing a diffusion surface; the diffusion surface is formed on one of the light entrance side and the exit side of the focusing plate 104. FIG. 1B is a vertical sectional view taken along line IB-IB of FIG. 1A. FIG. 2A shows a Fresnel lens FL1 composing a condensing surface that is formed on the other one of the light entrance side and the light exit side of the focusing plate 104 of Example 1. FIG. 2B is a vertical sectional view taken along line IIB-IIB of FIG. 2A.

The focusing plate in Example 1 is such that, as shown in FIGS. 1A and 1B, a plurality of microlenses ML1 having the same height and the same shape are arranged hexagonally and two-dimensionally at equal intervals to form a microlens assembly, and thereby form a diffusion surface 41. The radius of curvature of the microlenses ML1 is 152 μm, and the interval between apexes is 70 μm. The Fresnel lens FL1 of the condensing surface 42 is such that, as shown in FIGS. 2A and 2B, annular sections are disposed at equal intervals of 30 μm.

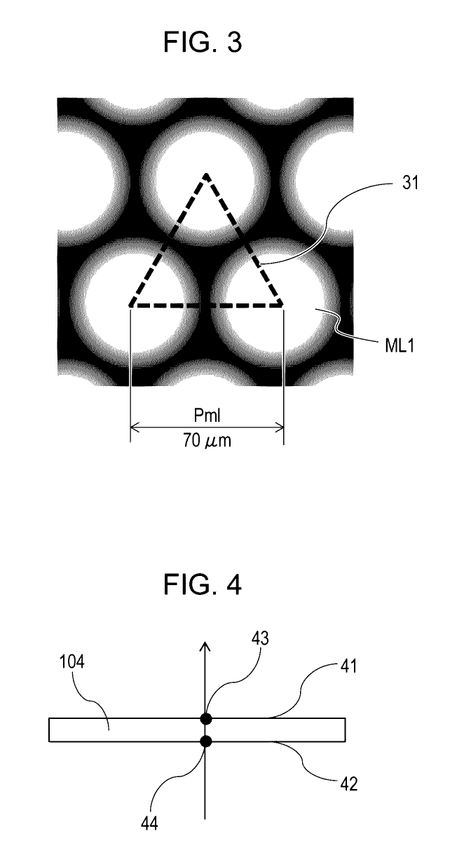

FIG. 3 illustrates a microlens assembly 31 composed of a plurality of microlenses ML1 in the configuration of Example 1. FIG. 4 is a sectional view of the main part of the focusing plate 104. In FIG. 4, reference numeral 41 denotes the diffusion surface of the focusing plate 104, and reference numeral 42 denotes the condensing surface of the focusing plate 104. Reference numeral 43 denotes a point on the diffusion surface 41, reference numeral 44 denotes a point on the condensing surface 42, and reference numerals 43 and 44 denote points situated at the same two-dimensional coordinate when the diffusion surface 41 and the condensing surface 42 are overlaid on each other in a direction perpendicular to the surfaces.

When the planes of the diffusion surface 41 and the condensing surface 42 are overlaid on each other in the positional relationship shown in FIG. 4, the arrangement period of the microlenses is longer than twice the interval between the annular sections of the Fresnel lens FL1. “Longer than twice the interval between the annular sections of the Fresnel lens FL1” means that when the length of the arrangement period of the microlenses is viewed in the distance in the radial direction of the annular sections, the arrangement period of the microlenses has a length larger than two annular sections.

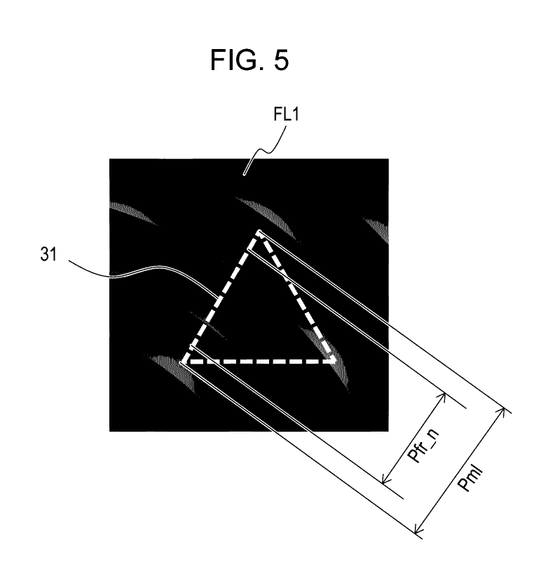

FIG. 5 illustrates a state where the microlens assembly 31 of the diffusion surface 41 and the annular sections of the Fresnel lens FL1 of the condensing surface 42 are overlaid on each other. FIG. 5 shows a state where the arrangement period of the microlenses is longer than twice the interval between the annular sections of the Fresnel lens FL1. Lines connecting the apexes of microlenses of a microlens assembly 31 composed of three microlenses shown in FIG. 3 form a regular triangle, and the length of one side thereof is denoted by Pml. The distance between the (n−1)th annular section and the (n+1)th annular section of the Fresnel lens FL1 of FIGS. 2A and 2B is denoted by Pfr_n.

Then, the following conditional expression (1) is satisfied:

Pml/Pfr_n>1.15 (1).

This is such a condition that when the length of the arrangement period of the microlenses is viewed from any angle, it is larger than twice the interval between the annular sections of the Fresnel lens FL1. When conditional expression (1) is satisfied, the arrangement period of the microlenses is longer than twice the interval between the annular sections of the Fresnel lens FL1 even when the diffusion surface 41 and the condensing surface 42 are overlaid on each other in anywhere of the focusing plate 104.

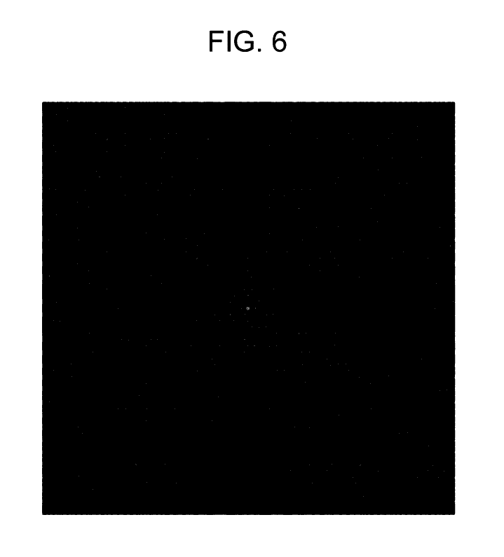

Next, the reason why the moire pattern can be reduced when conditional expression (1) is satisfied will be described. FIG. 6 illustrates the moire pattern when the focusing plate 104 of Example 1 is observed from the viewfinder system. FIG. 6 corresponds to the overlaying of FIG. 1A and FIG. 2A. The reason why the moire pattern observed from the viewfinder system is as shown in FIG. 6 is that when an observer observes through the viewfinder system, substantially the same images as the images shown in FIG. 1A and FIG. 2A are viewed by the eye of the observer.

However, because the periodic structure of the Fresnel lens and the microlenses is generally set so small that the Fresnel lens and the microlenses are not visible from the viewfinder system, the Fresnel lens and the microlenses are less likely to be visible from the observer. However, because the moire pattern resulting from the overlaying of them has a period larger than normal, only the moire pattern is observed from the viewfinder system.

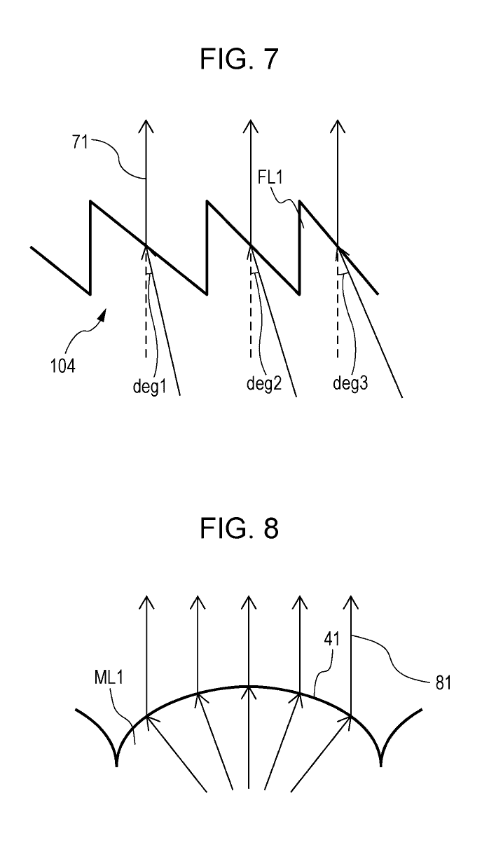

The Fresnel lens FL1 is composed of a plurality of annular sections. FIG. 7 is a schematic enlarged sectional view of the annular sections of the Fresnel lens FL1. Because the inclined surfaces of the annular sections of the Fresnel lens FL1 are at different angles, light rays 71 entering at different angles deg1, deg2, and deg3 are at the same angle when exiting from the Fresnel lens FL1, and are observed from the viewfinder system.

However, because the possible angles of the inclined surfaces of the annular sections are discrete, light rays between angles deg1 and deg2 and between angles deg2 and deg3 are not observed from the viewfinder system. As a result, parts of angles corresponding to parts between the annular sections are observed as dark lines from the viewfinder system.

FIG. 8 illustrates a state where light rays enter and exit from microlenses ML1. The microlenses ML1 guide light rays 81 entering at various angles to the viewfinder system. However, light rays at angles corresponding to ridges between the microlenses ML1 often do not enter. Therefore, no rays are guided from the ridges to the viewfinder system, and therefore the ridges between the microlenses ML1 look dark from the viewfinder system.

Owing to the interference of lightness difference caused by the Fresnel lens FL1 of the condensing surface 42 and the microlenses ML1 of the diffusion surface 41, a moire pattern is observed from the viewfinder system incorporating the focusing plate 104. In particular, when entering light rays are all at about the same angle, that is, when the F-number of the imaging lens is great, the angle of the dark lines is also uniform, and a moire pattern is likely to be observed. Conversely, when the range of angle of entering light rays is wide, that is, the F-number of the imaging lens is small, the range of refracting angle is also wide, and the dark lines also vary in angle, and therefore a moire pattern is less likely to be observed.

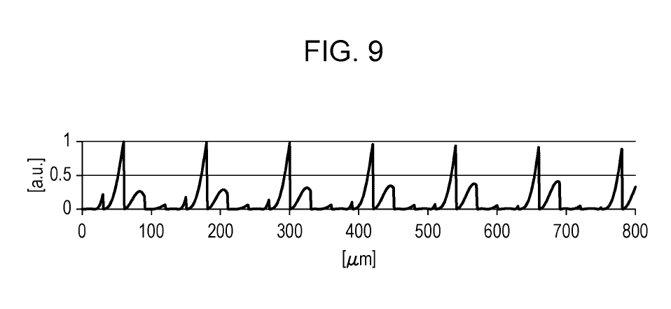

FIG. 9 shows the difference in lightness of a moire pattern that can be expressed as the overlaying of FIG. 1B and FIG. 2B. In Example 1, the microlens assembly 31 includes more than two annular sections of the Fresnel lens FL1.

In the case of such a configuration, the period of the moire pattern occurring in the focusing plate 104 is the same as the arrangement period of the smallest units. That is, the condition that the microlens assembly 31 includes two or more annular sections of the Fresnel lens FL1 is equal to a condition that the period of annular sections of the Fresnel lens exceeds the Nyquist frequency of the arrangement period of the microlenses. When this condition is satisfied, a moire pattern occurs with the same period as the microlenses ML1. Generally, microlenses themselves are set to such a size that they are not visible from the viewfinder. When such a condition is satisfied, a moire pattern is also less visible from the viewfinder system.

Next, a case where the focusing plate of Example 1 of the present invention is used in a viewfinder system will be described. In order for microlenses to be invisible from a viewfinder, it is necessary to reduce the length Pml to a certain value or less. The angle of view of the viewfinder is denoted by Fv (degree), and the image height on the focusing plate 104 corresponding to the angle of view Fv is denoted by h. When the following conditional expression (3) is satisfied, the possibility that the observer observes the microlenses is low:

Pml*Fv/h<0.090[°] (3).

### EXAMPLE 2

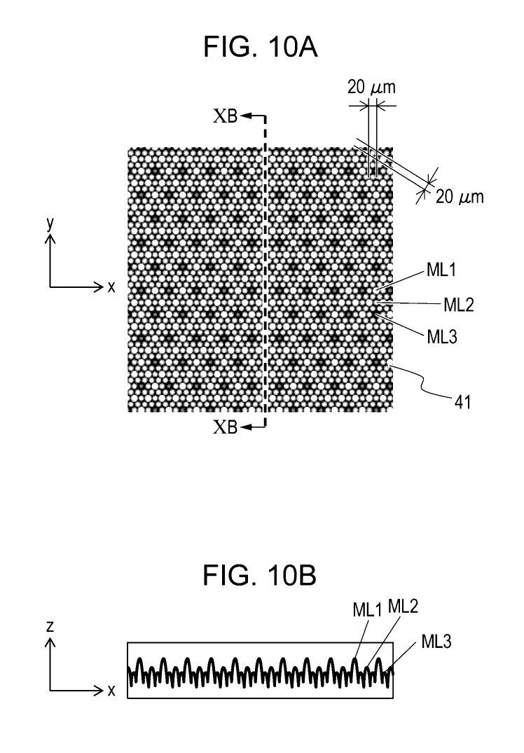

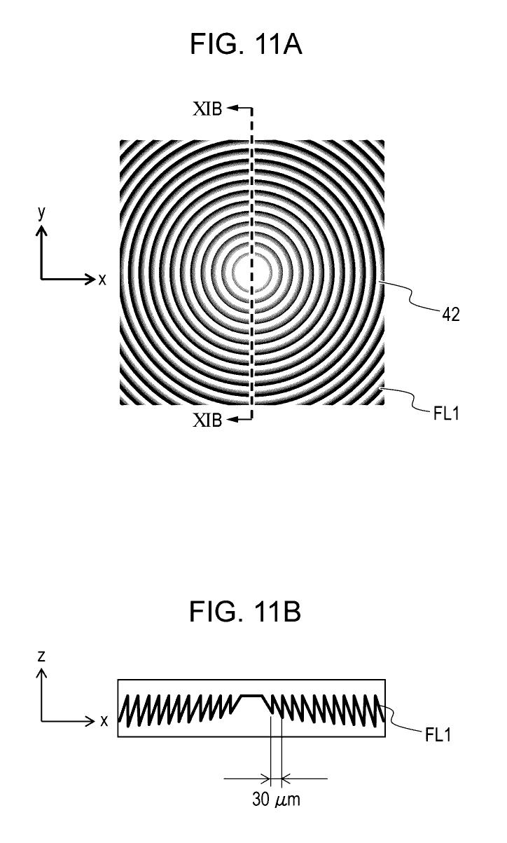

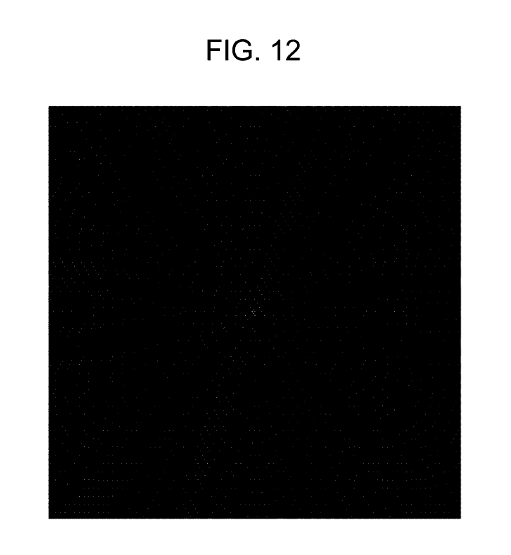

FIGS. 10A and 10B illustrate a focusing plate of Example 2 of the present invention. FIG. 10A illustrates the two-dimensional arrangement of microlenses MLi (i=1, 2, 3) composing a diffusion surface 41 that is formed on one of the light entrance side and the light exit side of the focusing plate 104. FIG. 10B is a sectional view thereof. FIG. 11A illustrates a Fresnel lens FL1 composing a condensing surface 42 that is formed on the other of the light entrance side and the light exit side of the focusing plate 104 of Example 2. FIG. 11B is a sectional view of FIG. 11A. FIG. 12 is an image such that the heights of image of the diffusion surface 41 of FIG. 10A and the condensing surface 42 of FIG. 11A are overlaid on each other, and shows a moire pattern created by the focusing plate 104 of Example 2.

The diffusion surface 41 of Example 2 is composed of three types of microlenses ML1, ML2, and ML3 having different heights, which are, in order of decreasing height of apex, microlenses ML1, microlenses ML2, and microlenses ML3. The apex interval between the microlenses Mi is 20 μm.

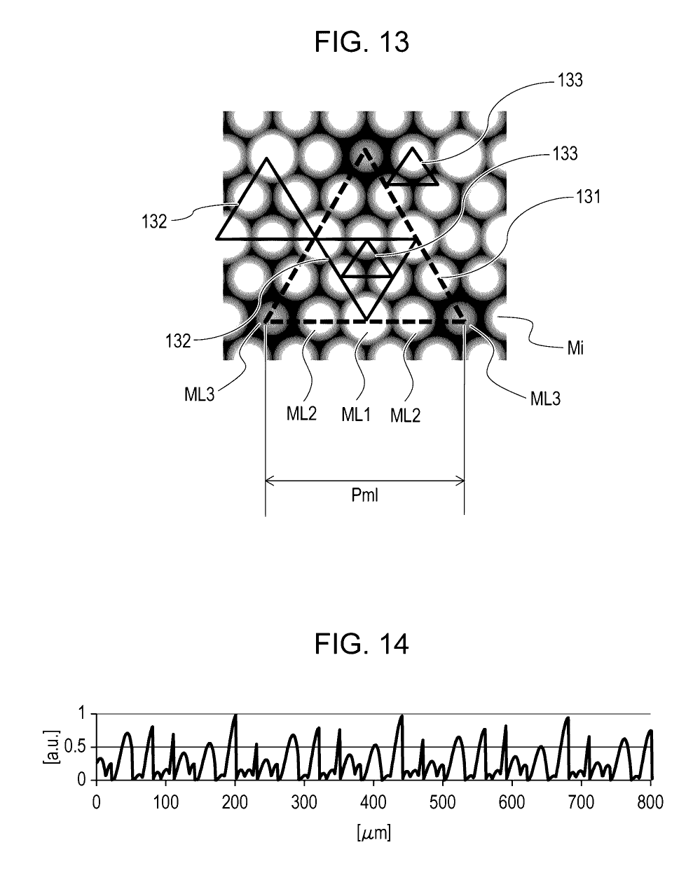

The diffusion surface of FIG. 13 has three microlens assemblies. A plurality of microlenses ML1 are periodically disposed to form a microlens unit 132. A plurality of microlenses ML2 are periodically disposed to form a microlens unit 133. A plurality of microlenses ML3 are periodically disposed to form a microlens unit 131.

A plurality of the microlens units 131 are periodically disposed to form a microlens assembly. Similarly, a plurality of the microlens units 132 are periodically disposed to form a microlens assembly. A plurality of the microlens units 133 are periodically disposed to form a microlens assembly. The number of microlenses and the repetition periods of the microlens units included in the three microlens assemblies differ from each other. The longest period of the periods on a plane of the microlenses composing the microlens units is the period of the microlens units 131.

The diffusion surface of FIG. 13 has three types of microlens units; each type of microlens unit is composed of three types of microlenses ML1, ML2, and ML3, and the shape of each microlens unit is a regular triangle as in Example 1. However, the size of each type of microlens unit is different; for example, the size (area) of microlens unit 131 is larger than the size of microlens unit 132 which is larger than the size of microlens unit 133. The condensing surface 42 of the focusing plate 104 of Example 2 is composed of a Fresnel lens FL1 having a pitch of 30 μm shown in FIGS. 11A and 11B. If the length of one side of the regular triangle of the microlens unit 131 shown in FIG. 13 is denoted by Pml, then Pml=80 μm, and expression (1) is satisfied in Example 2.

FIG. 14 illustrates the difference in lightness of a moire pattern that can be expressed as the overlaying of FIG. 10B and FIG. 11B. In Example 2, the period of the microlens unit 131 is specified so as to have a width greater than or equal to twice the period of the annular sections of the Fresnel lens FL1. Unlike Example 1, in Example 2, a moire pattern having a period different from the period of the microlens unit 131 occurs. This is caused by the fact that when the diffusion surface 41 is composed of three types of microlenses having different heights, the moire pattern observed from the viewfinder system differs from the moire pattern occurring on the diffusion surface 41 of Example 1.

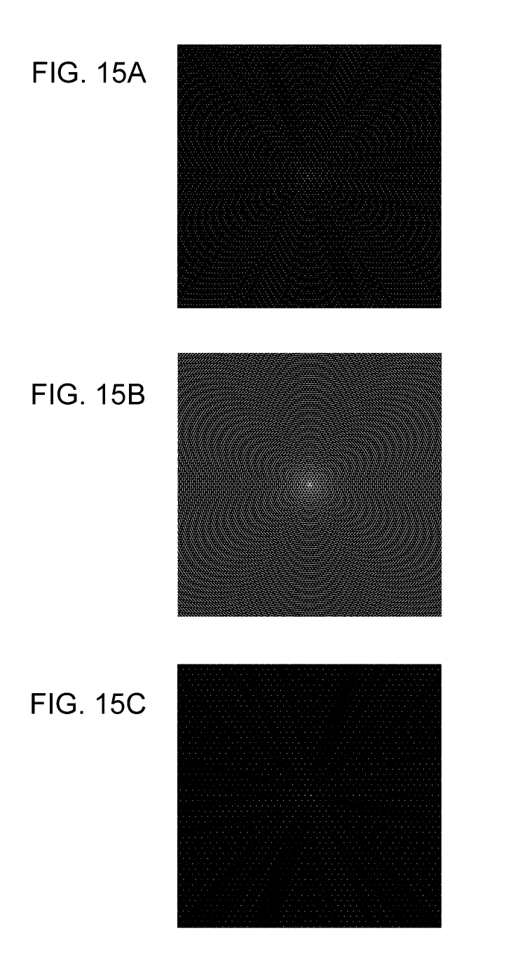

When, as in Example 2, the diffusion surface 41 is composed of a plurality of types of microlenses MLi, the moire patter observed from the viewfinder system is the sum of moire patterns occurring between microlenses MLi of respective heights and Fresnel lens FL. FIGS. 15A, 15B, and 15C show moire patterns created by three types of microlenses MLi having different heights. FIGS. 15A, 15B, and 15C respectively show moire patterns created by microlenses ML1 and Fresnel lens FL1, microlenses ML2 and Fresnel lens FL1, and microlenses ML3 and Fresnel lens FL1. The sum of FIGS. 15A, 15B, and 15C is equal to FIG. 12.

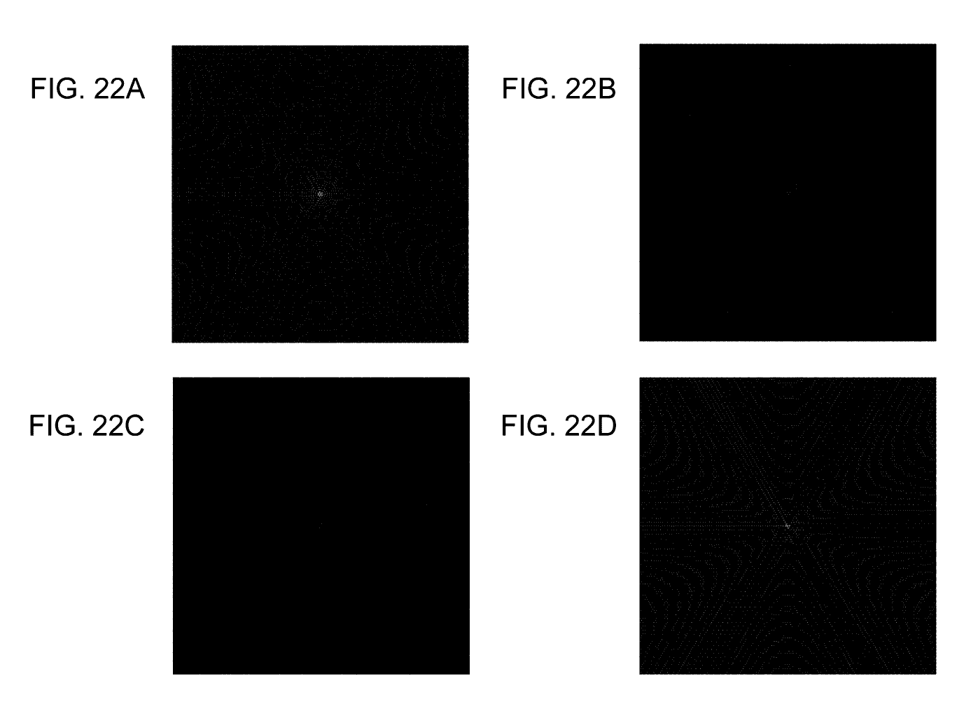

When microlens units are specified as in Example 2, the moire pattern can be reduced as shown in FIG. 12 by satisfying expression (1). FIGS. 22A, 22B, and 22C illustrate moire patterns in the case where for comparison, the microlens arrangement is the same as in Example 2, and the apex interval between the microlenses is set to 15 μm.

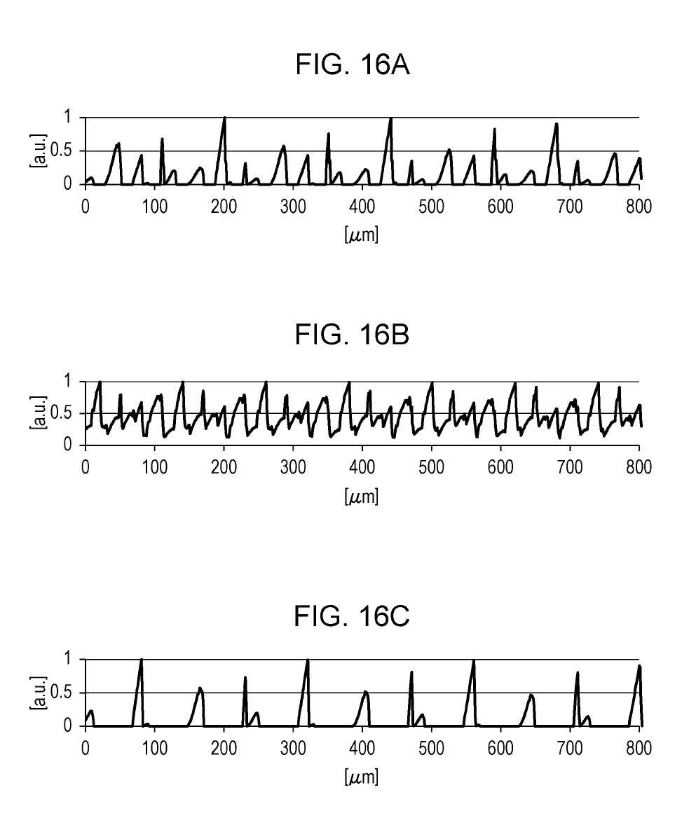

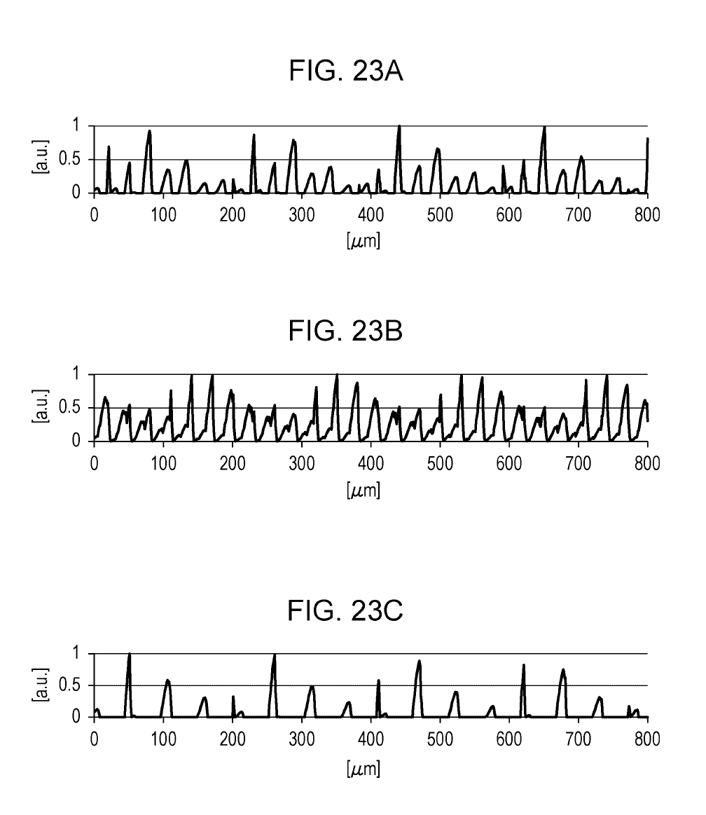

FIGS. 22A, 22B, and 22C respectively show moire patterns created by microlenses ML1 and Fresnel lens FL1, microlenses ML2 and Fresnel lens FL1, and microlenses ML3 and Fresnel lens FL1, and FIG. 22D shows the sum of them. The design values of FIGS. 22A to 22D do not satisfy the condition of expression (1). FIGS. 16A, 16B, and 16C show sectional views of FIGS. 15A, 15B, and 15C. FIGS. 23A, 23B, and 23C show sectional views of FIGS. 22A, 22B, and 22C. When FIG. 16C and FIG. 23C are compared, since FIG. 23C does not satisfy expression (1), the difference in lightness of FIG. 23C is larger than that of FIG. 16C.

In order to reduce all of the moire patterns on a diffusion surface 41 as in Example 2, it is necessary to make the interval between annular sections of the Fresnel lens FL1 smaller than half of the apex interval between microlenses the arrangement interval between which is the smallest. Although such a configuration is most desirable from the viewpoint of suppressing the moire pattern, the difficulty of processing and the influence of diffraction need to be taken into account when reducing the pitch of the Fresnel lens FL1.

For this reason, all things considered, it is not the best focusing plate. Therefore, when suppressing the moire pattern on a diffusion surface 41 composed of microlenses MLi, the moire pattern can be reduced compared to a focusing plate not satisfying expression (1) by adopting a configuration such that at least microlens units satisfy expression (1).

### EXAMPLE 3

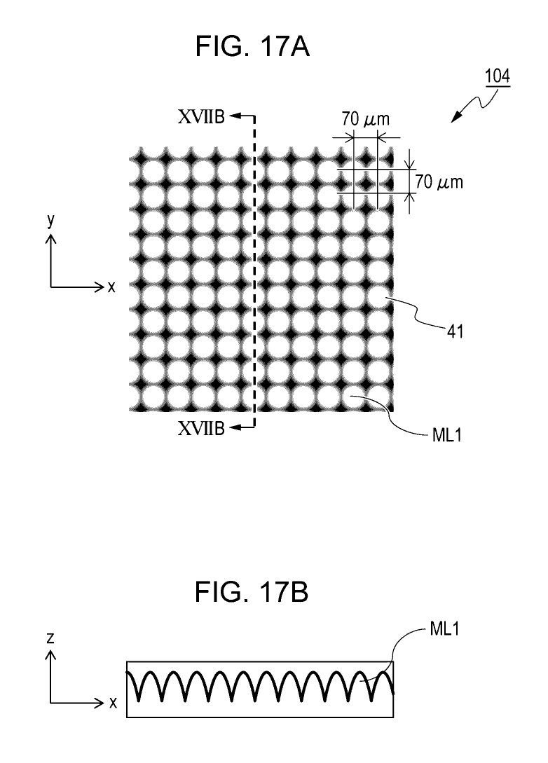

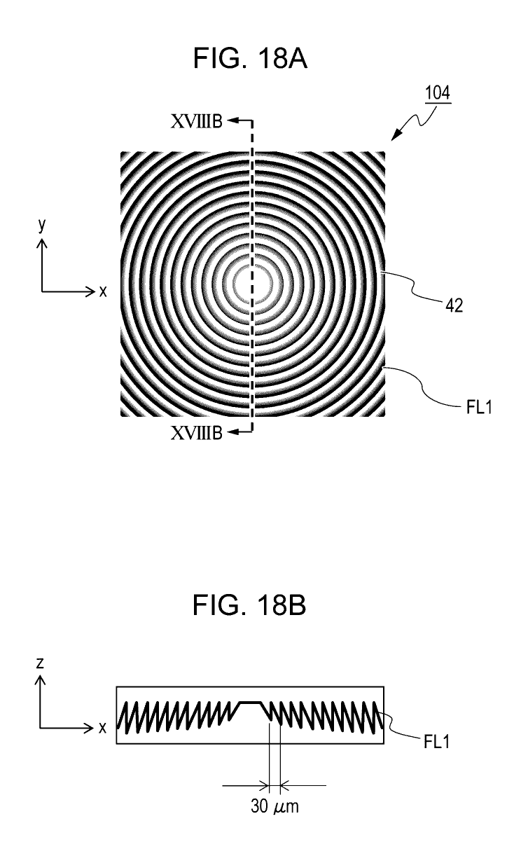

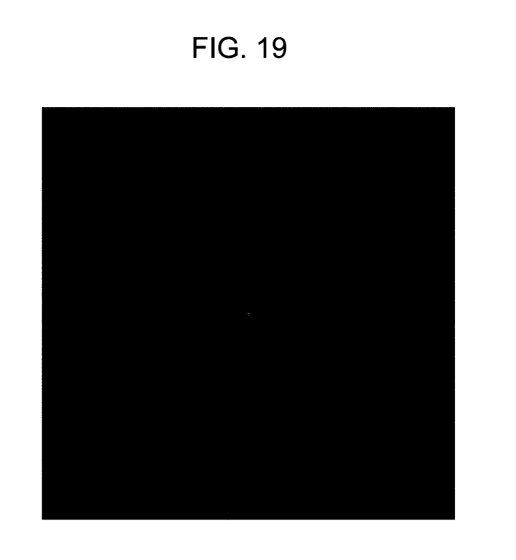

Next, a focusing plate 104 of Example 3 of the present invention will be described. FIG. 17A shows the two-dimensional arrangement of microlenses ML1 composing a diffusion surface 41 that is formed on one of the light entrance side and the light exit side of the focusing plate 104 of Example 3. FIG. 17B is a sectional view thereof. FIG. 18A shows a Fresnel lens FL1 composing a condensing surface 42 that is formed on the other of the light entrance side and the light exit side of the focusing plate 104 of Example 3. FIG. 18B is a sectional view thereof. FIG. 19 is the overlaying of the diffusion surface 41 of FIGS. 17A and 17B and the condensing surface 42 of FIGS. 18A and 18B, and illustrates a moire pattern created by the focusing plate 104 of Example 3.

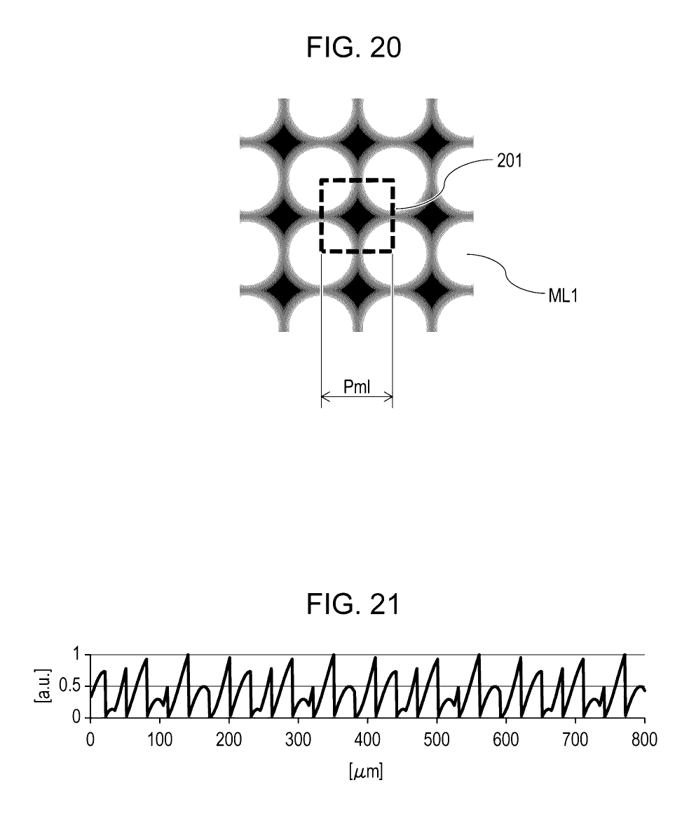

The focusing plate 104 in Example 3 is such that, as shown in FIGS. 17A and 17B, a plurality of microlenses ML1 having the same height and the same shape are arranged two-dimensionally at equal intervals to form a microlens assembly, and a diffusion surface 41 is thereby formed. FIG. 20 illustrates the microlens assembly 201 in the case of such a configuration. When the planes of the diffusion surface 41 and the condensing surface 42 are overlaid on each other, the arrangement period of the microlenses is longer than or equal to twice the arrangement interval of the annular sections of the Fresnel lens FL1.

Lines connecting the apexes of the plurality of microlenses ML1 of FIG. 20 form a square. The length of one side thereof is denoted by Pml. The distance between the (n−1)th annular section and the (n+1)th annular section of the Fresnel lens FL1 of FIGS. 18A and 18B is denoted by Pfr_n.

Then, the following conditional expression (2) is satisfied:

Pml/Pfr_n>2 (2).

This is such a condition that when, in a square arrangement, the length of the arrangement period of the microlens assembly 201 is viewed from any angle, it is larger than twice the interval between the annular sections of the Fresnel lens FL1. When this condition is satisfied, the arrangement period of the microlenses is longer than twice the interval between the annular sections of the Fresnel lens FL1 even when the diffusion surface 41 and the condensing surface 42 are overlaid on each other in anywhere of the focusing plate 104.

FIG. 17B is a sectional view showing the difference in height of the microlenses ML1 of Example 3, and FIG. 18B shows the difference in height of the Fresnel lens FL1. FIG. 21 illustrates the difference in lightness of a moire pattern that is expressed as the overlaying of FIG. 17B and FIG. 18B. In Example 3, the arrangement period of the microlenses is longer than twice the interval between the annular sections of the Fresnel lens FL1.

In the case of such a configuration, as with the case of Example 1, the period of the moire pattern expressed by light lines and dark lines is the same as the arrangement period of the microlenses ML1. That is, the period of annular sections of the Fresnel lens FL1 exceeds the Nyquist frequency of the arrangement of the microlenses. When this condition is satisfied, a moire pattern is not visible from the viewfinder system as long as the microlenses themselves are set to such a size that they are not visible from the viewfinder.

As described above, regardless of the manner in which microlenses ML1 are arranged, when the arrangement period of microlenses is longer than twice the interval between annular sections of the Fresnel lens FL1, the moire pattern visible from the viewfinder system is reduced. The same goes for the cases of other arrangements.

Although embodiments of the present invention have been described, the present invention is not limited to these embodiments, and variations and modifications may be made without departing from the scope of the present invention. As described above, according to the present invention, a focusing plate that has less graininess and in which the occurrence of a moire pattern is reduced, and a viewfinder system having the same can be easily obtained.

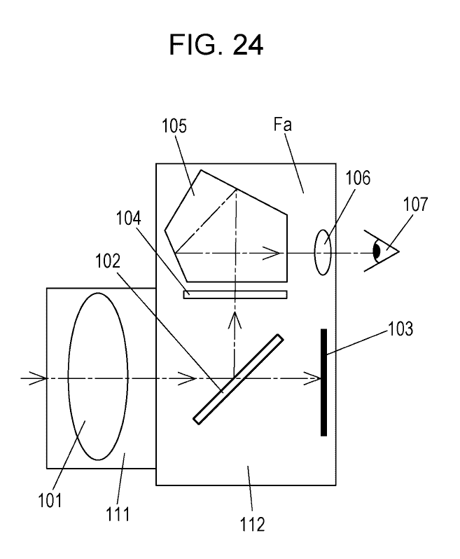

FIG. 24 is a schematic view of the main part of a single-lens reflex camera (imaging apparatus) including a viewfinder system having a focusing plate of the present invention. In the figure, light rays from an object pass through an imaging optical system 101 in a lens barrel 111, are reflected by a quick-return mirror 102 provided in a camera body 112, and are then guided to a focusing plate 104 disposed at a position optically equivalent to an imaging surface 103.

One surface of the focusing plate 104 in the figure is a diffusion surface disposed so as to be optically equivalent to the imaging surface 103. The viewfinder system Fa observes the imaging state of an object image on this surface, using the light ray passing through the focusing plate 104, through a pentagonal prism 105 and an eyepiece lens 106. The other surface of the focusing plate 104 is a surface having light condensing function (condensing surface), and has the function of condensing the light rays exiting from the exit pupil of the imaging optical system 101 mostly to a pupil 107 of an observer.

The light rays guided to the focusing plate 104 are inverted to an erect image by the pentagonal roof prism 105, are enlarged by passing through the eyepiece lens 106, and are then guided to the pupil position 107 of the observer. The object image formed on the focusing plate 104 is thereby observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-237324, filed Dec. 4, 2015, which is hereby incorporated by reference herein in its entirety.

What is claimed is:

1. A focusing plate having a light entrance side and a light exit side, comprising:
a Fresnel lens disposed on one of the light entrance side and the light exit side to form a condensing surface; and
a plurality of microlenses disposed on the other one of the light entrance side and the light exit side to form a diffusion surface,
wherein the condensing surface is formed by arranging the center of the Fresnel lens aligned with the center of the one of the light entrance side and the light exit side, and
wherein the diffusion surface is formed by arranging the plurality of microlenses two-dimensionally at equal intervals, and the apex interval between microlenses disposed adjacent to each other is longer than twice the interval between annular sections of the Fresnel lens.

2. The focusing plate according to claim 1,
wherein the arrangement of the plurality of microlenses is a hexagonal arrangement, and the arrangement the annular sections of the Fresnel lens is a concentric arrangement, and
wherein the following conditional expression is satisfied:
Pml/Pfr_n>1.15,
where Pml is the apex interval between microlenses disposed adjacent to each other, and Pfr_n is the radial distance between the (n−1)th annular section and the (n+1)th annular section from the center of the annular sections of the Fresnel lens.

3. The focusing plate according to claim 1,
wherein the arrangement of the plurality of microlenses is a square arrangement, and the arrangement the annular sections of the Fresnel lens is a concentric arrangement, and
wherein the following conditional expression is satisfied:
Pml/Pfr_n>2,
where Pml is the apex interval between microlenses disposed adjacent to each other, and Pfr_n is the radial distance between the (n−1)th annular section and the (n+1)th annular section from the center of the annular sections of the Fresnel lens.

4. A focusing plate having a light entrance side and a light exit side, comprising:
a condensing surface formed by a Fresnel lens disposed on one of the light entrance side and the light exit side; and
a diffusion surface formed by a plurality of microlenses disposed on the other one of the light entrance side and the light exit side,
wherein the diffusion surface is composed of a plurality of microlens assemblies each formed by periodically arranging microlens units each formed by arranging microlenses having the same shape two-dimensionally at equal intervals, the repetition periods of microlens units included in the plurality of microlens assemblies differ from each other, and the interval between two microlenses included in the microlens unit having the longest repetition period is longer than twice the interval between annular sections of the Fresnel lens.

5. The focusing plate according to claim 4,
wherein the condensing surface is formed by arranging the center of the Fresnel lens aligned with the center of the one of the light entrance side and the light exit side,
wherein the arrangement of the annular sections of the Fresnel lens is a concentric arrangement,
wherein the microlens units are each composed of three microlenses, and
wherein lines connecting the apexes of the three microlenses form a triangle, and the following conditional expression is satisfied:
Pml/Pfr_n>1.15,
where Pml is the length of one side of the triangle, and Pfr_n is the radial distance between the (n−1)th annular section and the (n+1)th annular section from the center of the annular sections of the Fresnel lens.

6. A viewfinder optical system comprising:
a focusing plate having a light entrance side and a light exit side on one of which a Fresnel lens is disposed to form a condensing surface and on the other of which a plurality of microlenses are disposed to form a diffusion surface; and
an eyepiece optical system for observing an object image formed on the focusing plate,
wherein, in the focusing plate,
the diffusion surface is formed by arranging the plurality of microlenses two-dimensionally at equal intervals,
the condensing surface is formed by arranging the center of the Fresnel lens aligned with the center of the one of the light entrance side and the light exit side, and
the apex interval between microlenses disposed adjacent to each other is longer than twice the interval between annular sections of the Fresnel lens.

7. The viewfinder optical system according to claim 6,
wherein the arrangement of the plurality of microlenses is a hexagonal arrangement, and the arrangement of the annular sections of the Fresnel lens is a concentric arrangement, and
wherein the following conditional expression is satisfied:
Pml*Fv/h<0.090[°],
where Pml is the apex interval between microlenses disposed adjacent to each other, h is the height of an image formed on the focusing plate, and Fv[°] is the angle of view of the viewfinder optical system corresponding to the height h.

8. A viewfinder optical system comprising:
a focusing plate having light entrance side and a light exit side on one of which a Fresnel lens is disposed to form a condensing surface and on the other of which a plurality of microlenses are disposed to form a diffusion surface; and
an eyepiece optical system for observing an object image formed on the focusing plate,
wherein, in the focusing plate,
the condensing surface is formed by arranging the center of the Fresnel lens aligned with the center of one of the light entrance side and the light exit side, the arrangement of the annular sections of the Fresnel lens is a concentric arrangement,
the diffusion surface is composed of a plurality of microlens assemblies each formed by periodically arranging microlens units each formed by arranging microlenses having the same shape two-dimensionally at equal intervals, the repetition periods of microlens units included in the plurality of microlens assemblies differ from each other, and the interval between two microlenses included in the microlens unit having the longest repetition period is longer than twice the interval between annular sections of the Fresnel lens.

9. The viewfinder optical system according to claim 8,
wherein the microlens units are each composed of three microlenses, lines connecting the apexes of the three microlenses form a triangle, and
wherein the following conditional expression is satisfied:
Pml*Fv/h<0.090[°],
where Pml is the length of one side of the triangle, h is the height of an image formed on the focusing plate, and Fv[°] is the angle of view of the viewfinder optical system corresponding to the height h.
